(19) United States
(12) Patent Application Publication
(10) Pub. No.: US 2011/0157558 A1
(43) Pub. Date: Jun. 30, 2011

(54) BEAM SPLITTING APPARATUS

(75) Inventor: TUNG-CHI LEE, TAICHUNG COUNTY (TW)

(73) Assignee: TUNG-CHI LEE, TAICHUNG COUNTY (TW)

(21) Appl. No.: 12/829,394

(22) Filed: Jul. 2, 2010

(30) Foreign Application Priority Data
Dec. 31, 2009 (TW) 098146392

(51) Int. Cl. G03B 21/14; G02B 26/00

(52) U.S. Cl. 353/31; 359/203.1

(57) ABSTRACT

A beam splitting apparatus applicable for a projecting system is provided. The beam splitting apparatus comprises a shaft, a plurality of dichroic mirrors and a housing. The shaft and the dichroic mirrors are surrounded and sealed by the housing. The outer surface of the shaft is screw-surrounded by the dichroic mirrors. The dichroic mirrors rotate with the shaft and split an incident light into a plurality of primary color light beams, and scroll the position of the primary color light beams circularly. The beam splitting apparatus can reduce the noise and the energy loss, and raise the display frames rate to increase the display quality.

### CROSS-REFERENCE TO RELATED APPLICATIONS

This U.S. non-provisional patent application claims priority under 35 U.S.C. §119 of Taiwan Patent Application No. 098146392, filed on Dec. 31, 2009, the entire contents of which are hereby incorporated by reference.

### BACKGROUND OF THE INVENTION

1. Field of the Invention

The present invention relates to a beam splitting apparatus; in particular, the present invention relates to a spiral beam splitting apparatus.

2. Description of Related Art

At present, the imaging method of the common projection system in the market is to split the incident light beam (white light) into a plurality of primary color light beams such as red light, green light and blue light etc. in the first, and then to integrate the primary color light beams mentioned above to project an image. The projection system can be classified into the three-panel type and the single-panel type according to the number of the display panel. The beam splitting apparatus with common three-panel type has three dichroic mirrors to split the incident light beam into three primary color light beams, transmit the three primary color light beams to an display panel to form an image, and then obtain the complete image via the lens. The three-panel type projection system has higher light usage efficiency, but has complicated structure. The beam splitting apparatus with the single-panel type is the color wheel. The color wheel has a plurality of filters to filter the incident light beam into a single primary color light beam in time sequence, and then the three primary color light beams are transmitted into the display panel sequentially. The single-panel type projection system has simple structure, but has lower light usage efficiency.

A scrolling-type beam splitting apparatus for the single-panel type projection system is disclosed in U.S. Pat. No. 7,284,865. Please refer to FIG. 1 for a schematic view of a conventional scrolling-type beam splitting projection system. As shown in the figure, an incident light beam 102 generated by a light source 101 enters three dichroic mirrors disposed spirally on the outside of a shaft 103, wherein the three dichroic mirrors are a red dichroic mirror 111R, a green dichroic mirror 112G and a blue dichroic mirror 113B. The incident light beam 102 is split into a red light beam 121, a green light beam 122 and a blue light beam 123 simultaneously, and the useless incident light beam 124 then passes trough the shaft 103 to get away. After each color light beam is reflected to a relay lens set 105 via a reflective mirror 104, the relay lens set 105 calibrates the parallelism and the shape of the primary color light beams to refract the primary color light beams to an display panel 106. When the scrolling-type beam splitting apparatus starts to rotate, the appearing positions of each color light beam in the display panel 106 scroll from bottom to top continuously and circularly.

However, when each dichroic mirror of the scrolling-type beam splitting apparatus keeps spirally rotating, each dichroic mirror rubs against the air to generate huge noise and energy loss. Such that the rotational speed of this apparatus is restricted and the display frame rate can not be raised.

### SUMMARY OF THE INVENTION

Therefore, one objective of the present invention is to provide a beam splitting apparatus to overcome the problem of huge noise and energy loss due to the friction between the dichroic mirrors and the air during the operation of the conventional scrolling-type beam splitting apparatus.

In accordance with the objective of the present invention, a beam splitting apparatus is provided. The beam splitting apparatus comprises: a shaft rotating around an axis; a plurality of dichroic mirrors spirally surrounding the shaft and disposed on the outer surface of the shaft, the dichroic mirrors rotating with the shaft to split an incident light beam into a plurality of primary color light beams; and a housing surrounding and sealing the shaft and the dichroic mirrors.

In accordance with another objective of the present invention, a beam splitting apparatus is provided. The beam splitting apparatus comprises: a shaft rotating around an axis; and a plurality of dichroic mirror sets spirally surrounding the shaft and disposed on the outer surface of the shaft, the dichroic mirrors rotating with the shaft to split an incident light beam into a plurality of primary color light beams.

In one embodiment, the beam splitting apparatus further comprises a housing surrounding the outside of the shaft and the dichroic mirror sets and sealing the beam splitting apparatus.

As mentioned previously, the beam splitting apparatus of the invention has the following advantages:

(1) reducing the noise and the energy loss substantially by the sealing housing of the beam splitting apparatus;

(2) raising the display frames rate to increase the display quality with the dichroic mirror sets of the beam splitting apparatus.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the figures:

FIG. 1 is a schematic view of a conventional scrolling-type beam splitting projection system;

FIG. 2(A) is a side view of a dichroic mirror of a beam splitting apparatus in accordance with a first preferred embodiment of the present invention;

FIG. 2(B) is a top view of a dichroic mirror of a beam splitting apparatus in accordance with a first preferred embodiment of the present invention;

FIG. 3 is a geometric arrangement schematic view of a dichroic mirror of a beam splitting apparatus in accordance with a first preferred embodiment of the present invention;

FIG. 4 is a schematic view of a beam splitting apparatus in accordance with a first preferred embodiment of the present invention;

FIG. 5(A) is a side view of a dichroic mirror of a beam splitting apparatus with the 0° operation status in accordance with a first preferred embodiment of the present invention;

FIG. 5(B) is a top view of a dichroic mirror of a beam splitting apparatus with the 0° operation status in accordance with a first preferred embodiment of the present invention;

FIG. 5(C) is a geometric arrangement schematic view of a dichroic mirror of a beam splitting apparatus with the 0° operation status in accordance with a first preferred embodiment of the present invention;

FIG. 5(D) is a schematic view of the position on the display panel of the primary color beams of a dichroic mirror of a beam splitting apparatus with the 0° operation status in accordance with a first preferred embodiment of the present invention;

FIG. 6(A) is a side view of a dichroic mirror of a beam splitting apparatus with the 60° operation status in accordance with a first preferred embodiment of the present invention;

FIG. 6(B) is a top view of a dichroic mirror of a beam splitting apparatus with the 60° operation status in accordance with a first preferred embodiment of the present invention;

FIG. 6(C) is a geometric arrangement schematic view of a dichroic mirror of a beam splitting apparatus with the 60° operation status in accordance with a first preferred embodiment of the present invention;

FIG. 6(D) is a schematic view of the position on the display panel of the primary color beams of a dichroic mirror of a beam splitting apparatus with the 60° operation status in accordance with a first preferred embodiment of the present invention;

FIG. 7(A) is a side view of a dichroic mirror of a beam splitting apparatus with the 120° operation status in accordance with a first preferred embodiment of the present invention;

FIG. 7(B) is a top view of a dichroic mirror of a beam splitting apparatus with the 120° operation status in accordance with a first preferred embodiment of the present invention;

FIG. 7(C) is a geometric arrangement schematic view of a dichroic mirror of a beam splitting apparatus with the 120° operation status in accordance with a first preferred embodiment of the present invention;

FIG. 7(D) is a schematic view of the position on the display panel of the primary color beams of a dichroic mirror of a beam splitting apparatus with the 120° operation status in accordance with a first preferred embodiment of the present invention;

FIG. 8(A) is a side view of a dichroic mirror of a beam splitting apparatus with the 180° operation status in accordance with a first preferred embodiment of the present invention;

FIG. 8(B) is a top view of a dichroic mirror of a beam splitting apparatus with the 180° operation status in accordance with a first preferred embodiment of the present invention;

FIG. 8(C) is a geometric arrangement schematic view of a dichroic mirror of a beam splitting apparatus with the 180° operation status in accordance with a first preferred embodiment of the present invention;

FIG. 8(D) is a schematic view of the position on the display panel of the primary color beams of a dichroic mirror of a beam splitting apparatus with the 180° operation status in accordance with a first preferred embodiment of the present invention;

FIG. 9(A) is a side view of a dichroic mirror of a beam splitting apparatus with the 240° operation status in accordance with a first preferred embodiment of the present invention;

FIG. 9(B) is a top view of a dichroic mirror of a beam splitting apparatus with the 240° operation status in accordance with a first preferred embodiment of the present invention;

FIG. 9(C) is a geometric arrangement schematic view of a dichroic mirror of a beam splitting apparatus with the 240° operation status in accordance with a first preferred embodiment of the present invention;

FIG. 9(D) is a schematic view of the position on the display panel of the primary color beams of a dichroic mirror of a beam splitting apparatus with the 240° operation status in accordance with a first preferred embodiment of the present invention;

FIG. 10(A) is a side view of a dichroic mirror of a beam splitting apparatus with the 300° operation status in accordance with a first preferred embodiment of the present invention;

FIG. 10(B) is a top view of a dichroic mirror of a beam splitting apparatus with the 300° operation status in accordance with a first preferred embodiment of the present invention;

FIG. 10(C) is a geometric arrangement schematic view of a dichroic mirror of a beam splitting apparatus with the 300° operation status in accordance with a first preferred embodiment of the present invention;

FIG. 10(D) is a schematic view of the position on the display panel of the primary color beams of a dichroic mirror of a beam splitting apparatus with the 300° operation status in accordance with a first preferred embodiment of the present invention;

FIG. 11(A) is a side view of a dichroic mirror of a beam splitting apparatus in accordance with a second preferred embodiment of the present invention;

FIG. 11(B) is a top view of a dichroic mirror of a beam splitting apparatus in accordance with a second preferred embodiment of the present invention;

FIG. 12 is a geometric arrangement schematic view of a dichroic mirror of a beam splitting apparatus in accordance with a second preferred embodiment of the present invention;

FIG. 13(A) is a side view of a dichroic mirror of a beam splitting apparatus in accordance with a third preferred embodiment of the present invention;

FIG. 13(B) is a top view of a dichroic mirror of a beam splitting apparatus in accordance with a third preferred embodiment of the present invention;

FIG. 14 is a geometric arrangement schematic view of a dichroic mirror of a beam splitting apparatus in accordance with a third preferred embodiment of the present invention;

FIG. 15 is a schematic view of a beam splitting apparatus in accordance with a third preferred embodiment of the present invention;

FIG. 16(A) is a geometric arrangement schematic view of a dichroic mirror of a beam splitting apparatus with the 0° operation status in accordance with a third preferred embodiment of the present invention;

FIG. 16(B) is a schematic view of the position on the display panel of the primary color beams of a dichroic mirror of a beam splitting apparatus with the 0° operation status in accordance with a third preferred embodiment of the present invention;

FIG. 17(A) is a geometric arrangement schematic view of a dichroic mirror of a beam splitting apparatus with the 30° operation status in accordance with a third preferred embodiment of the present invention;

FIG. 17(B) is a schematic view of the position on the display panel of the primary color beams of a dichroic mirror of a beam splitting apparatus with the 30° operation status in accordance with a third preferred embodiment of the present invention;

FIG. 18(A) is a geometric arrangement schematic view of a dichroic mirror of a beam splitting apparatus with the 60° operation status in accordance with a third preferred embodiment of the present invention;

FIG. 18(B) is a schematic view of the position on the display panel of the primary color beams of a dichroic mirror of a beam splitting apparatus with the 60° operation status in accordance with a third preferred embodiment of the present invention;

FIG. 19(A) is a geometric arrangement schematic view of a dichroic mirror of a beam splitting apparatus with the 90° operation status in accordance with a third preferred embodiment of the present invention;

FIG. 19(B) is a schematic view of the position on the display panel of the primary color beams of a dichroic mirror of a beam splitting apparatus with the 90° operation status in accordance with a third preferred embodiment of the present invention;

FIG. 20(A) is a geometric arrangement schematic view of a dichroic mirror of a beam splitting apparatus with the 120° operation status in accordance with a third preferred embodiment of the present invention;

FIG. 20(B) is a schematic view of the position on the display panel of the primary color beams of a dichroic mirror of a beam splitting apparatus with the 120° operation status in accordance with a third preferred embodiment of the present invention;

FIG. 21(A) is a geometric arrangement schematic view of a dichroic mirror of a beam splitting apparatus with the 150° operation status in accordance with a third preferred embodiment of the present invention;

FIG. 21(B) is a schematic view of the position on the display panel of the primary color beams of a dichroic mirror of a beam splitting apparatus with the 150° operation status in accordance with a third preferred embodiment of the present invention;

FIG. 22(A) is a geometric arrangement schematic view of a dichroic mirror of a beam splitting apparatus with the 180° operation status in accordance with a third preferred embodiment of the present invention;

FIG. 22(B) is a schematic view of the position on the display panel of the primary color beams of a dichroic mirror of a beam splitting apparatus with the 180° operation status in accordance with a third preferred embodiment of the present invention;

FIG. 23(A) is a geometric arrangement schematic view of a dichroic mirror of a beam splitting apparatus with the 210° operation status in accordance with a third preferred embodiment of the present invention;

FIG. 23(B) is a schematic view of the position on the display panel of the primary color beams of a dichroic mirror of a beam splitting apparatus with the 210° operation status in accordance with a third preferred embodiment of the present invention;

FIG. 24(A) is a geometric arrangement schematic view of a dichroic mirror of a beam splitting apparatus with the 240° operation status in accordance with a third preferred embodiment of the present invention;

FIG. 24(B) is a schematic view of the position on the display panel of the primary color beams of a dichroic mirror of a beam splitting apparatus with the 240° operation status in accordance with a third preferred embodiment of the present invention;

FIG. 25(A) is a geometric arrangement schematic view of a dichroic mirror of a beam splitting apparatus with the 270° operation status in accordance with a third preferred embodiment of the present invention;

FIG. 25(B) is a schematic view of the position on the display panel of the primary color beams of a dichroic mirror of a beam splitting apparatus with the 270° operation status in accordance with a third preferred embodiment of the present invention;

FIG. 26(A) is a geometric arrangement schematic view of a dichroic mirror of a beam splitting apparatus with the 300° operation status in accordance with a third preferred embodiment of the present invention;

FIG. 26(B) is a schematic view of the position on the display panel of the primary color beams of a dichroic mirror of a beam splitting apparatus with the 300° operation status in accordance with a third preferred embodiment of the present invention;

FIG. 27(A) is a geometric arrangement schematic view of a dichroic mirror of a beam splitting apparatus with the 330° operation status in accordance with a third preferred embodiment of the present invention;

FIG. 27(B) is a schematic view of the position on the display panel of the primary color beams of a dichroic mirror of a beam splitting apparatus with the 330° operation status in accordance with a third preferred embodiment of the present invention.

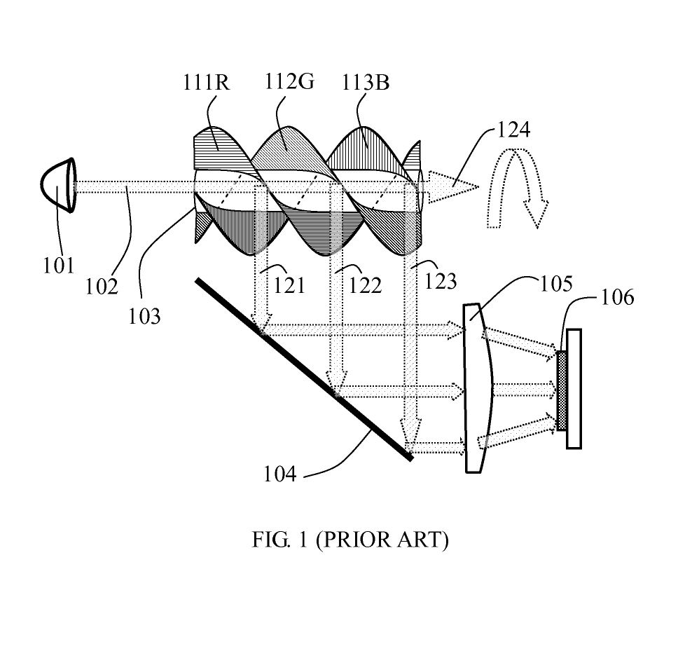

### DETAILED DESCRIPTION OF THE PREFERRED EMBODIMENTS

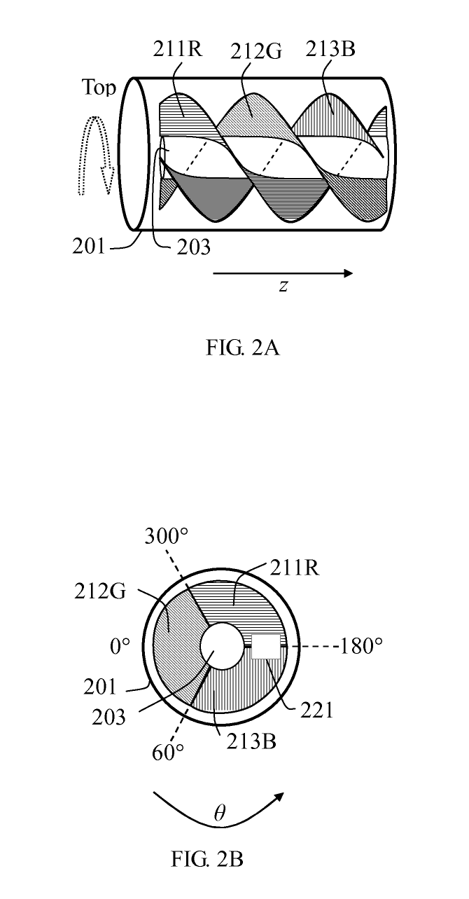

Please refer to FIG. 2 for a side view and a top view of a dichroic mirror of a beam splitting apparatus in accordance with a first preferred embodiment of the present invention. As shown in the figure, the beam splitting apparatus of the present invention is applicable for a projection system to split an incident light beam into a plurality of color beams. The beam splitting apparatus comprises a housing 201 with the cylinder shape, a shaft 203 and a plurality of dichroic mirrors, wherein the dichroic mirrors further comprise a red dichroic mirror 211R, a green dichroic mirror 212G and a blue dichroic mirror 213B. The dichroic mirrors screw-surround the shaft 230 and are disposed on the outer surface of the shaft 203 such that the dichroic mirrors and the shaft 203 rotate around an axis synchronously.

A housing 201 with the cylinder shape surrounds the outside of the dichroic mirrors (211R, 212G and 213B) and the shaft 203, and rotates around the axis with the shaft 203 synchronously. The housing 201 is formed in transparent shape and the inside of the housing 201 may be hollow or be filled with the transparent material. Besides, the shaft 203 may be a cylinder, and the inside of the shaft 203 may be hollow or solid.

Via the housing 201, the dichroic mirrors will not rub against the air to prevent the noise and reduce the energy loss during the operation of the present beam splitting apparatus.

As shown in the FIG. 2(B) for a top view of the dichroic mirrors, the red dichroic mirror 211R extends spirally around one circle from the 300° position of the front end of the shaft 203 to the 300° position of the rear end of the shaft 203 for reflecting a red light beam and making the other part of incident light beams to pass through the red dichroic mirror 211R. The green dichroic mirror 212G extends spirally around one circle from the 60° position of the front end of the shaft 203 to the 60° position of the rear end of the shaft 203 for reflecting a green light beam and making the other part of incident light beams to pass through the green dichroic mirror 212G. The blue dichroic mirror 213B extends spirally around one circle from the 180° position of the front end of the shaft 203 to the 180° position of the rear end of the shaft 203 for reflecting a blue light beam and making the other part of incident light beams to pass through the blue dichroic mirror 213B. In this embodiment, an incident area 221 represents the incident situation and the reflect situation of the incident light beam as an example. The Z axis is the lengthwise axis of the housing 201 with the cylinder shape, and θ is angle surrounding the housing 201 and the shaft 203.

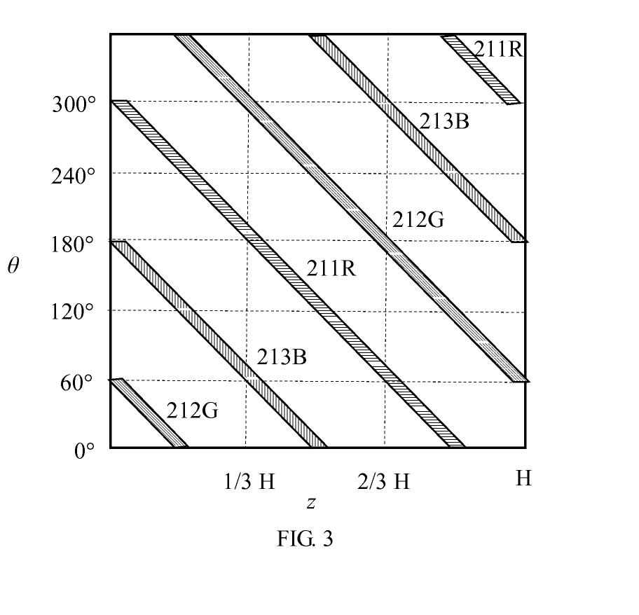

Please refer to FIG. 3 for a geometric arrangement schematic view of a dichroic mirror of a beam splitting apparatus in accordance with a first preferred embodiment of the present invention. As shown in the figure, H is the length alone the Z direction of the housing 201. The red dichroic mirror 211R surrounds the shaft 203 spirally around one circle from θ=300° and the Z=0 position to θ=300° and the Z=H position. The green dichroic mirror 212G surrounds the shaft 203 spirally around one circle from θ=60° and the Z=0 position to θ=60° and the Z=H position. The blue dichroic mirror 213B surrounds the shaft 203 spirally around one circle from θ=60° and the Z=0 position to θ=60° and the Z=H position. The dichroic mirrors are placed with a phase shift to each other such that the phase shift equals to the quotient of 360° dividing by the number of the dichroic mirrors. There are three dichroic mirrors in this embodiment, so the dichroic mirrors are placed with 120° phase shift to each other.

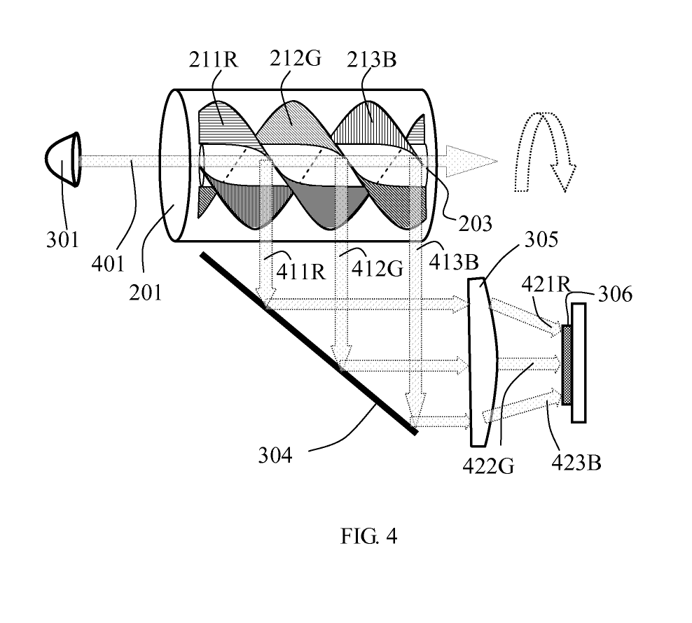

Please refer to FIG. 4 for a schematic view of a beam splitting apparatus in accordance with a first preferred embodiment of the present invention. The beam splitting apparatus of the present invention comprises a light source 301, a housing 201, a shaft 203, a plurality of dichroic mirrors (212R, 212G and 213B), a reflective mirror 304, a relay lens set 305 and an display panel 306.

The light source 301 is disposed in the front of the housing 201 and generates an incident light beam 401 to the beam splitting apparatus. The incident light beam 401 will be reflected to extract a red light beam 411R by the red dichroic mirror 211R, be reflected to extract a green light beam 412G by the green dichroic mirror 212G and be reflected to extract a blue light beam 413B by the blue dichroic mirror 213B simultaneously. The remaining part of the incident light beam 401 passes through the blue dichroic mirror 213B.

All reflected primary color light beams (411R, 412G and 413B) are reflected to the reflective mirror 304. The reflective mirror 304 is disposed on one side of the housing 201 in parallel to change the propagation directions of the color light beams (411R, 412G and 413B), and reflects the light beams (411R, 412G and 413B) toward the relay lens set 305. The relay lens set 305 is disposed between the optical paths of the primary color light beams which have been reflected by the reflective mirror 304 in order to adjust the shape of the primary color light beams (411R, 412G and 413B), integrate light beams and make the primary color light beams (411R, 412G and 413B) toward the display panel 306. The display panel 306 is disposed between the optical paths of the color light beams which have transmitted through the relay lens 305 in order to modulate the integrated primary color light beams into an image of projection. With the rotation of the shaft 203, the appearing position of each primary color light beam in the display panel 306 periodically appears in the bottom of the display panel 306 and moves to the top of the display panel 306.

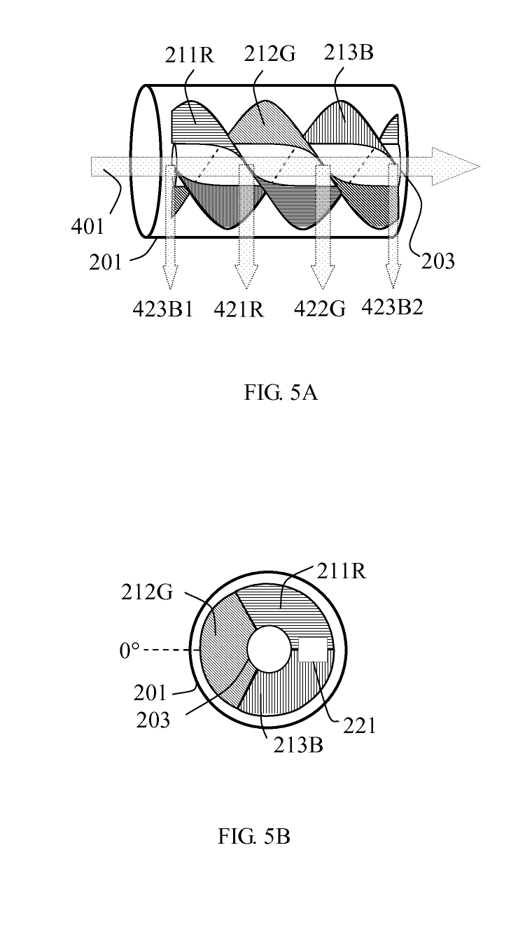

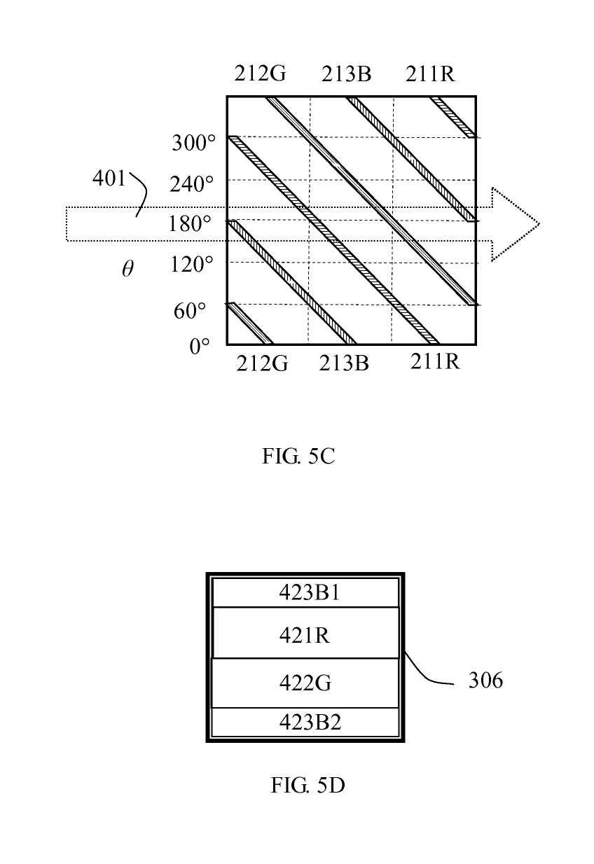

Please refer to FIGS. 5˜10 for an operation view of a beam splitting apparatus in accordance with a first preferred embodiment of the present invention. As shown in the FIG. 5(B), for easily understanding the beam splitting sequence of the incident light beam 401, we just discuss the incident area 221 which is illuminated by part of the incident light beam 401 in this embodiment. The situation corresponds to FIG. 5(C) for illuminating the housing 201 in θ=180° position of the housing 201, and the rotating angle of the housing 201 is 0° at this time.

The incident light beam 401 is reflected by the upper part of the blue dichroic mirror 213B to extract the blue light beam 423B1, and the other part of the incident light beam 401 passes through the blue dichroic mirror 213B to the green dichroic mirror 212G. Then the incident light beam 401 is reflected by the green dichroic mirror 212G to extract the green light beam 422G, and the other part of the incident light beam 401 passes through the green dichroic mirror 212G to the red dichroic mirror 211R. Then, the incident light beam 401 is reflected by the red dichroic mirror 211R to extract the red light beam 421R, and the other part of the incident light beam 401 passes through the red dichroic mirror 211R to the blue dichroic mirror 213B. Finally the incident light beam 401 is reflected by the lower part of the blue dichroic mirror 213B to extract the blue light beam 423B2.

After the reflection and combination of the reflective mirror 304 and the relay lens set 305 shown in FIG. 4, the position of each basic color light beam in the display panel 306 is shown in FIG. 5(D), and the sequence from top to bottom is the blue light beam 423B1, the red light beam 421R, the green light beam 422G and the blue light beam 423B2.

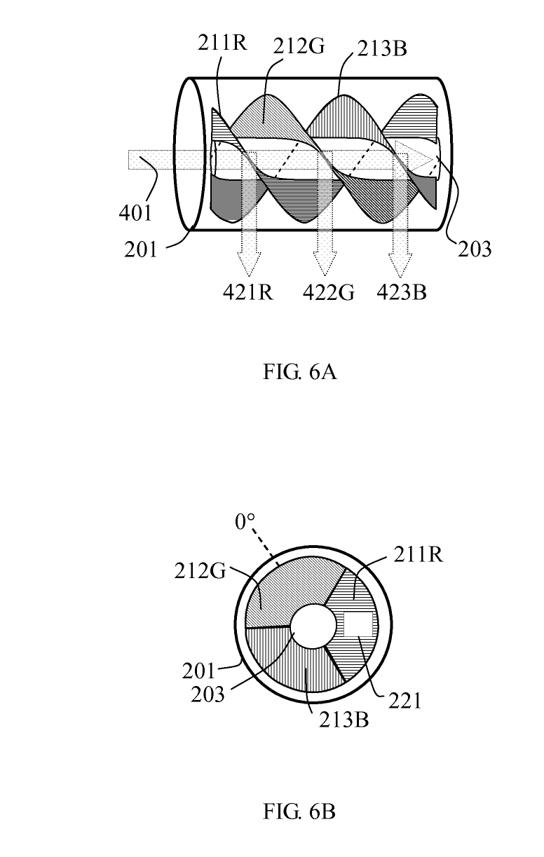

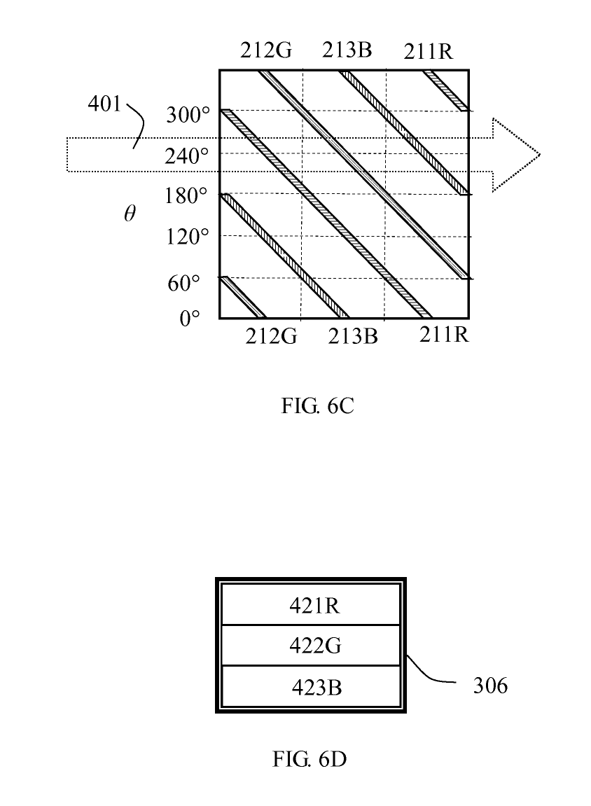

As shown in FIG. 6(B), the rotation angle of the housing 201 is 60° at this time, and the incident area 221 illuminated by the incident light beam 401 corresponds to the situation of FIG. 6(C) for illuminating the housing 201 in θ=240° position of the housing 201. The reflection status of each primary color light beam is shown in FIG. 6(A). Because the incident area 221 corresponds to different dichroic mirrors, the beam splitting sequence of the incident light beam 401 is red, green and blue (blue, red, green and blue in FIG. 5). The beam split status is the same with the illustration in FIG. 5, and will be omitted here.

In this rotating situation, the position of each primary color light beam in the display panel 306 is finally shown in FIG. 6(D), and the sequence from top to bottom is the red light beam 421R, the green light beam 422G and the blue light beam 423B, wherein the position of each primary color light beam in the display panel 306 moves upward.

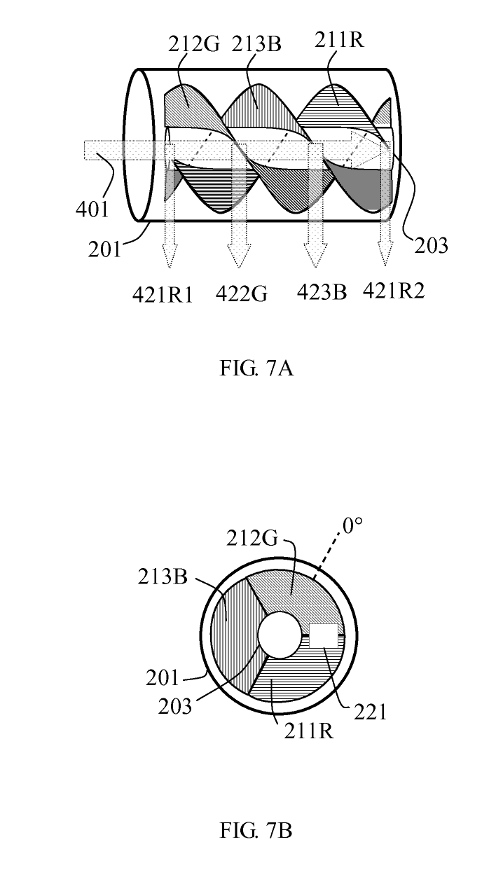

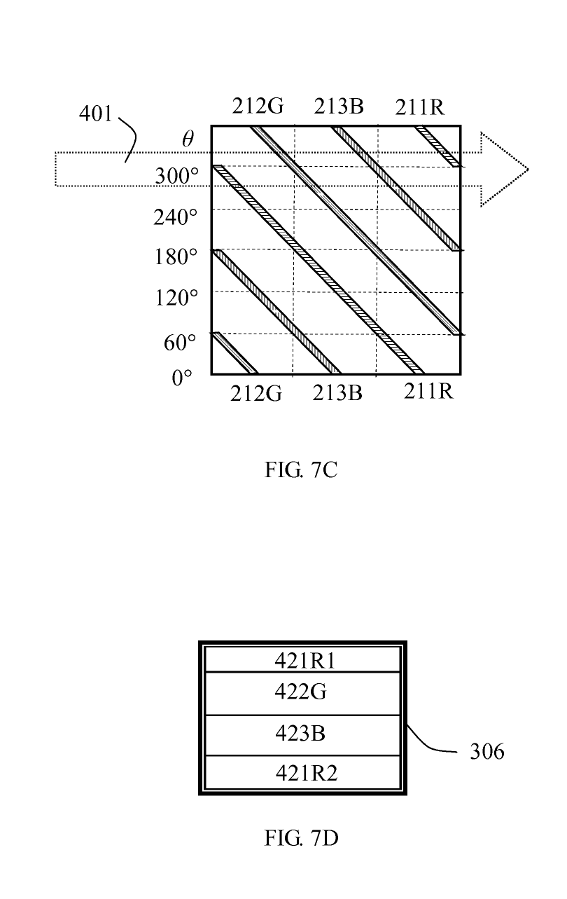

As shown in FIG. 7(B), the rotation angle of the housing 201 is 120° at this time, and the incident area 221 illuminated by the incident light beam 401 corresponds to the situation of FIG. 7(C) for illuminating the housing 201 in θ=300° position of the housing 201. The reflection status of each primary color light beam is shown in FIG. 7(A). Because the incident area 221 corresponds to different dichroic mirrors, the beam splitting sequence of the incident light beam 401 is red, green, blue and red. The beam split status is the same with the illustration in FIG. 5, and will be omitted here.

In this rotating situation, the position of each primary color light beam in the display panel 306 is finally shown in FIG. 7(D), and the sequence from top to bottom is the red light beam 421R1, the green light beam 422G, the blue light beam 423B and the red light beam 421R2, wherein the position of each primary color light beam in the display panel 306 moves upward.

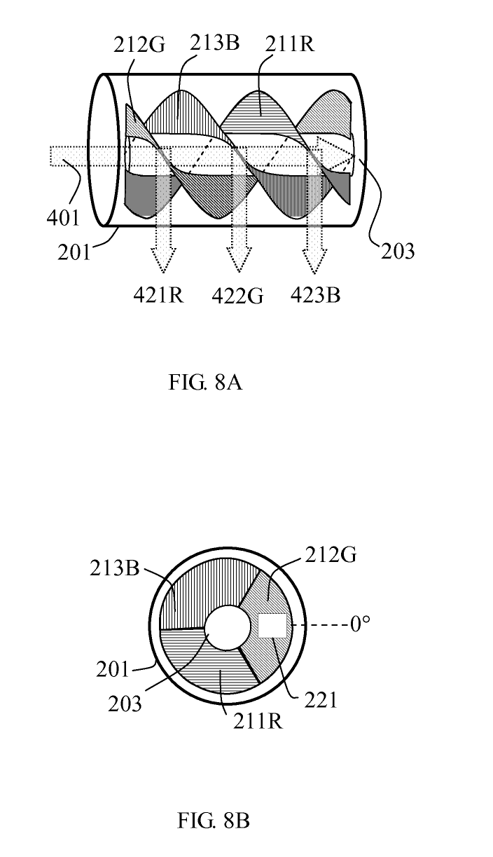

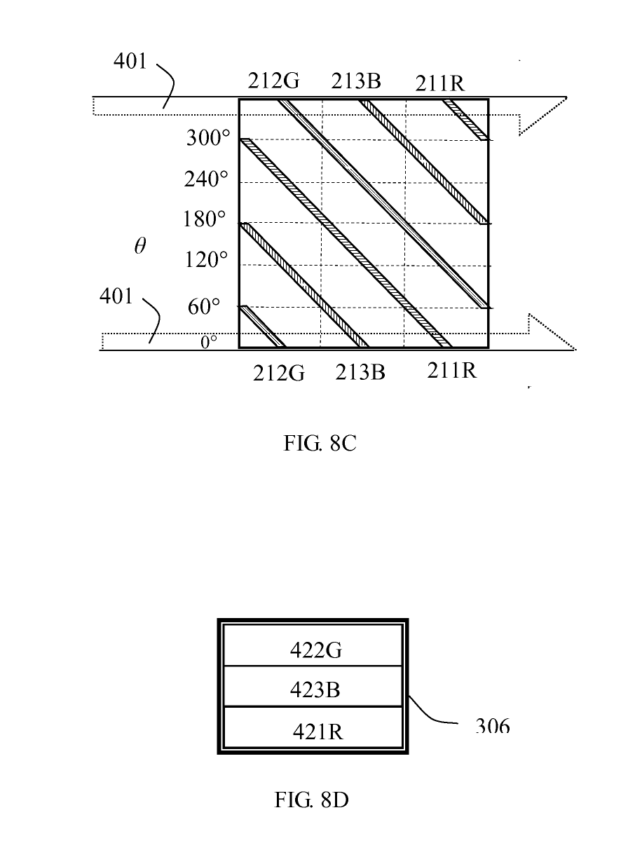

As shown in FIG. 8(B), the rotation angle of the housing 201 is 180° at this time, and the incident area 221 illuminated by the incident light beam 401 corresponds to the situation of FIG. 8(C) for illuminating the housing 201 in θ=0° position of the housing 201. The reflection status of each primary color light beam is shown in FIG. 8(A). Because the incident area 221 corresponds to different dichroic mirrors, the beam splitting sequence of the incident light beam 401 is green, blue and red. The beam split status is the same with the illustration in FIG. 5, and will be omitted here.

In this rotating situation, the position of each primary color light beam in the display panel 306 is finally shown in FIG. 8(D), and the sequence from top to bottom is the green light beam 422G, the blue light beam 423B and the red light beam 421R, wherein the position of each primary color light beam in the display panel 306 moves upward.

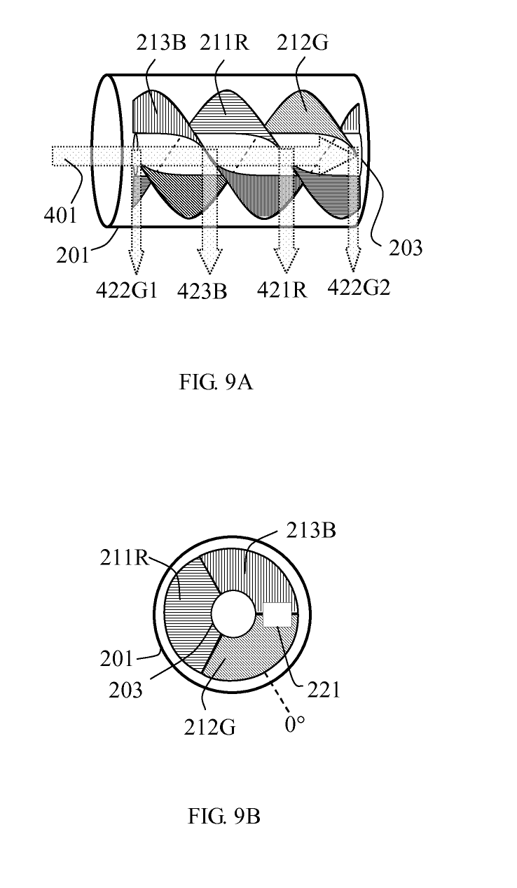

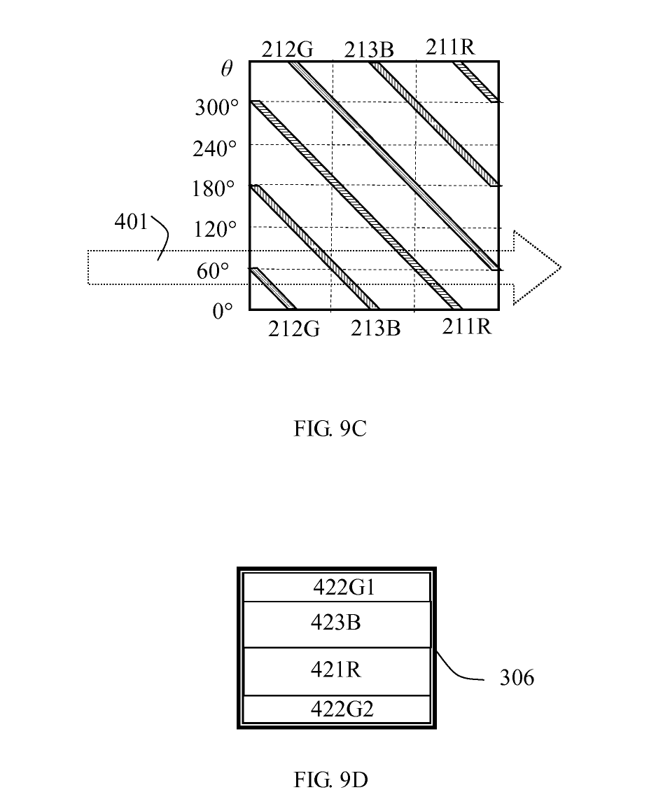

As shown in FIG. 9(B), the rotation angle of the housing 201 is 240° at this time, and the incident area 221 illuminated by the incident light beam 401 corresponds to the situation of FIG. 9(C) for illuminating the housing 201 in θ=60° position of the housing 201. The reflection status of each basic color light beam is shown in FIG. 9(A). Because the incident area 221 corresponds to different dichroic mirrors, the beam splitting sequence of the incident light beam 401 is green, blue, red and green. The beam split status is the same with the illustration in FIG. 5, and will be omitted here.

In this rotating situation, the position of each primary color light beam in the display panel 306 is finally shown in FIG. 9(D), and the sequence from top to bottom is the green light beam 422G1, the blue light beam 423B, the red light beam 421R and the green light beam 422G2, wherein the position of each primary color light beam in the display panel 306 moves upward.

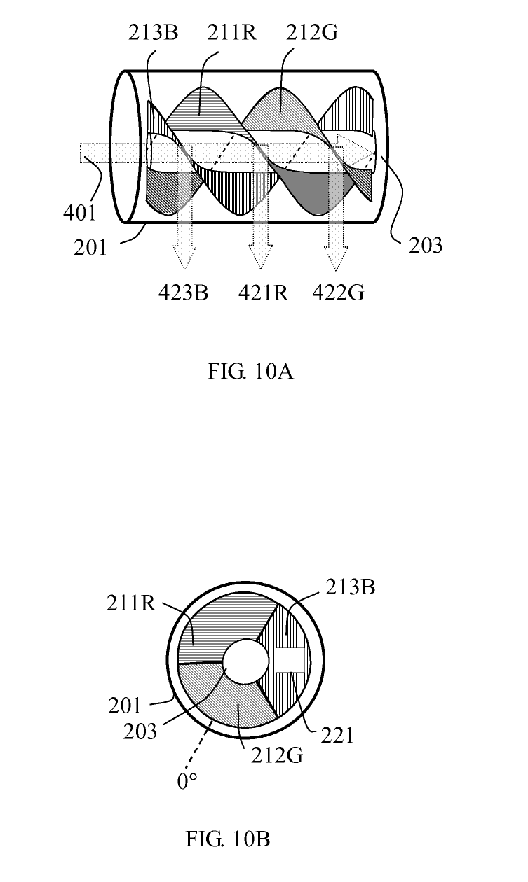

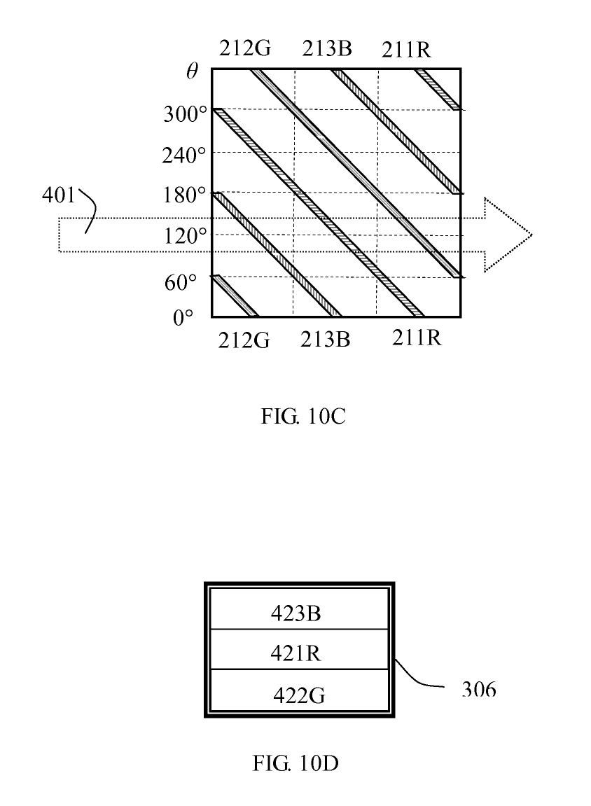

As shown in FIG. 10(B), the rotation angle of the housing 201 is 300° at this time, and the incident area 221 illuminated by the incident light beam 401 corresponds to the situation of FIG. 10(C) for illuminating the housing 201 in θ=120° position of the housing 201. The reflection status of each primary color light beam is shown in FIG. 10(A). Because the incident area 221 corresponds to different dichroic mirrors, the beam splitting sequence of the incident light beam 401 is blue, red and green. The beam split status is the same with the illustration in FIG. 5, and will be omitted here.

In this rotating situation, the position of each primary color light beam in the display panel 306 is finally shown in FIG. 10(D), and the sequence from top to bottom is the blue light beam 423B, the red light beam 421R and the green light beam 422G, wherein the position of each primary color light beam in the display panel 306 moves upward.

By the circulation of the beam splitting steps, we can split the incident light beam continuously and smoothly to obtain each primary color light beam for the follow-up combination to display the image.

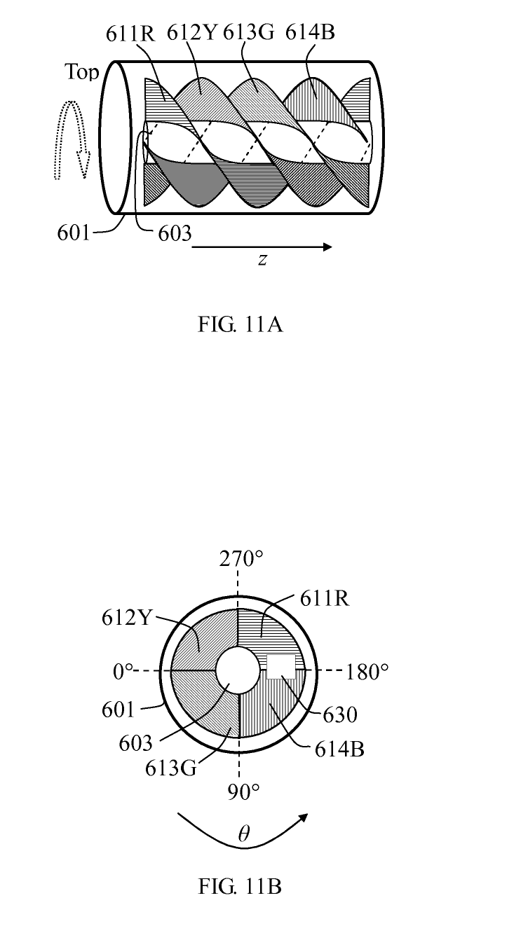

Please refer to FIG. 11 for a side view and a top view of a dichroic mirror of a beam splitting apparatus in accordance with a second preferred embodiment of the present invention. As shown in the figure, the beam splitting apparatus of the present invention is applicable for a projection system to split an incident light beam into a plurality of color light beams. The beam splitting apparatus comprises a housing 601 with the cylinder shape, a shaft 603 and a plurality of dichroic mirrors, wherein the dichroic mirrors further comprise a red dichroic mirror 611R, a yellow dichroic mirror 612Y, a green dichroic mirror 613G and a blue dichroic mirror 614B. The dichroic mirrors screw-surround the shaft 603 and are disposed on the outer surface of the shaft 603 such that the dichroic mirrors and the shaft 603 rotate around an axis synchronously.

A housing 601 with the cylinder shape surrounds the outside of the dichroic mirrors (611R, 612Y, 613G and 614B) and the shaft 603, and rotates around the axis with the shaft 603 synchronously. The housing 601 is formed in transparent shape and the inside of the housing 601 may be hollow or be filled with the transparent material. Besides, the shaft 603 may be a cylinder, and the inside of the shaft 603 may be hollow or solid.

Via the housing 601, the dichroic mirrors will not rub against the air to avoid the generation of the noise and reduce the loss of the energy during the operation of the present beam splitting apparatus.

As shown in the FIG. 11(B) for a top view of the dichroic mirrors, the red dichroic mirror 611R extends spirally around one circle from the 270° position of the front end of the shaft 603 to the 270° position of the rear end of the shaft 603 for reflecting a red light light beam and making the other part of incident light beam to pass through the red dichroic mirror 611R. The yellow dichroic mirror 612Y extends spirally around one circle from the 0° position of the front end of the shaft 603 to the 0° position of the rear end of the shaft 603 for reflecting a yellow light beam and making the other part of incident light beam to pass through the yellow dichroic mirror 612Y. The green dichroic mirror 613G extends spirally around one circle from the 90° position of the front end of the shaft 603 to the 90° position of the rear end of the shaft 603 for reflecting a green light beam and making the other part of incident light beam to pass through the green dichroic mirror 613G. The blue dichroic mirror 614B extends spirally around one circle from the 180° position of the front end of the shaft 603 to the 180° position of the rear end of the shaft 603 for reflecting a blue light beam and making the other part of incident beam to pass through the blue dichroic mirror 614B. In this embodiment, an incident area 630 represents the incident situation and the reflect situation of the incident light beam as an example. The Z axis is the lengthwise axis of the housing 601 with the cylinder shape, and θ is angle surrounding the housing 601 and the shaft 603.

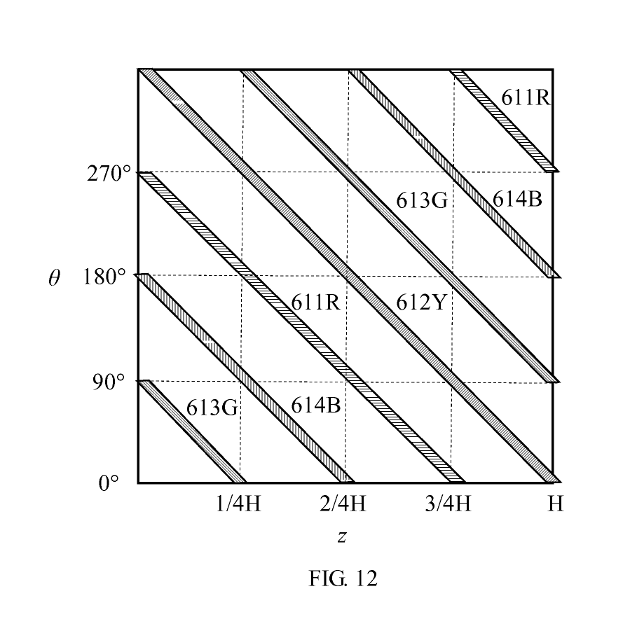

Please refer to FIG. 12 for a geometric arrangement schematic view of a dichroic mirror of a beam splitting apparatus in accordance with a second preferred embodiment of the present invention. As shown in the figure, H is the length alone the Z direction of the housing 601. The red dichroic mirror 611R surrounds the shaft 603 spirally around one circle from θ=270° and the Z=0 position to θ=270° and the Z=H position. The yellow dichroic mirror 612Y surrounds the shaft 603 spirally around one circle from θ=0° and the Z=0 position to θ=0° and the Z=H position. The green dichroic mirror 613G surrounds the shaft 603 spirally around one circle from θ=90° and the Z=0 position to θ=90° and the Z=H position. The blue dichroic mirror 614B surrounds the shaft 603 spirally around one circle from θ=180° and the Z=0 position to θ=180° and the Z=H position.

The dichroic mirrors are placed with a phase shift to each other such that the phase shift equals to the quotient of 360° dividing by the number of the dichroic mirrors. There are four dichroic mirrors in this embodiment, so the dichroic mirrors are placed with 90° phase shift to each other. Besides, the operation of the second embodiment is the same with the operation of the first embodiment. The number of the primary color light beams is four, and the circulating showing sequence of the primary color light beams is the red light beam, the yellow light beam, the green light beam and the blue light beam. The other detail illustration will be omitted here.

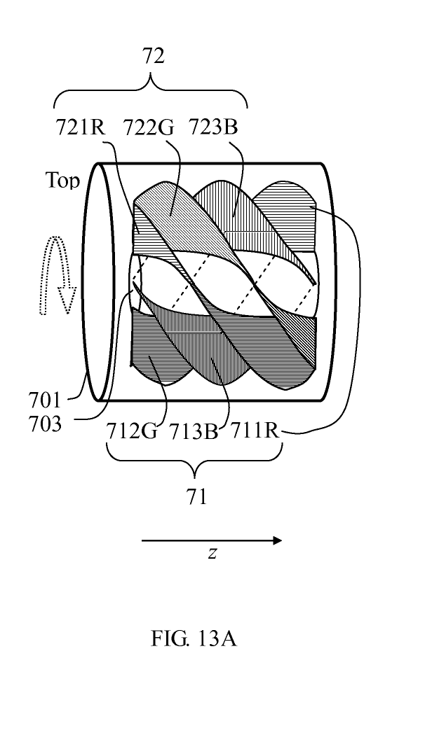

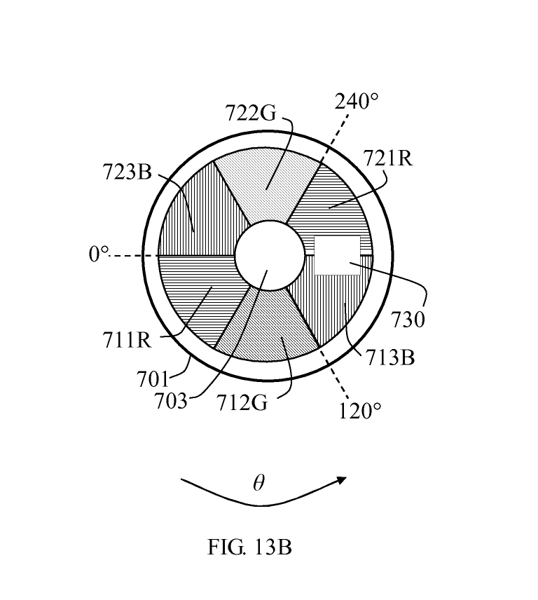

Please refer to FIG. 13 for a side view and a top view of a dichroic mirror of a beam splitting apparatus in accordance with a third preferred embodiment of the present invention. As shown in the figure, the beam splitting apparatus of the present invention is applicable for a projection system to split an incident light beam into a plurality of color light beams. The beam splitting apparatus comprises a housing 701 with the cylinder shape, a shaft 703 and a plurality of dichroic mirror sets (a first dichroic mirror set 71 and a second dichroic mirror set 72), wherein the first dichroic mirror set 71 comprises a red dichroic mirror 711R, a green dichroic mirror 712G and a blue dichroic mirror 713B and the second dichroic mirror set 72 comprises a red dichroic mirror 721R, a green dichroic mirror 722G and a blue dichroic mirror 723B

The dichroic mirrors screw-surround the shaft 703 and are disposed on the outer surface of the shaft 703 such that the dichroic mirrors and the shaft 703 rotate around an axis synchronously.

A housing 701 with the cylinder shape surrounds the outside of the dichroic mirror sets (71 and 72) and the shaft 703, and rotates around the axis with the shaft 703 synchronously. The housing 701 is formed in transparent cylinder shape and the inside of the housing 701 may be hollow or be filled with the transparent material. Besides, the shaft 703 may be a cylinder, and the inside of the shaft 703 may be hollow or solid. Via the housing 701, the dichroic mirrors will not rub against the air to avoid the generation of the noise and reduce the loss of the energy during the operation of the present beam splitting apparatus.

As shown in the FIG. 13(B) for a top view of the dichroic mirrors, the red dichroic mirror 711R of the first dichroic mirror set 71 extends spirally around half circle from the 60° position of the front end of the shaft 703 to the 240° position of the rear end of the shaft 703 for reflecting a red light beam and making the other part of incident light beam to pass through the red dichroic mirror 711R. The green dichroic mirror 712G extends spirally around half circle from the 120° position of the front end of the shaft 703 to the 300° position of the rear end of the shaft 703 for reflecting a green light beam and making the other part of incident light beam to pass through the green dichroic mirror 713G. The blue dichroic mirror 713B extends spirally around half circle from the 180° position of the front end of the shaft 703 to the 0° position of the rear end of the shaft 703 for reflecting a blue light beam and making the other part of incident light beam to pass through the blue dichroic mirror 713B.

The red dichroic mirror 712R of the second dichroic mirror set 72 extends spirally around half circle from the 240° position of the front end of the shaft 703 to the 60° position of the rear end of the shaft 703 for reflecting a red light beam and making the other part of incident light beams to pass through the red dichroic mirror 712R. The green dichroic mirror 722G extends spirally around half circle from the 300° position of the front end of the shaft 703 to the 120° position of the rear end of the shaft 703 for reflecting a green light beam and making the other part of incident beam to pass through the green dichroic mirror 722G. The blue dichroic mirror 723B extends spirally around half circle from the 0° position of the front end of the shaft 703 to the 180° position of the rear end of the shaft 703 for reflecting a blue light beam and making the other part of incident light beam to pass through the blue dichroic mirror 723B. In this embodiment, an incident area 730 represents the incident situation and the reflect situation of the incident light beam as an example. The Z axis is the lengthwise axis of the housing 701 with the cylinder shape, and θ is angle surrounding the housing 701 and the shaft 703.

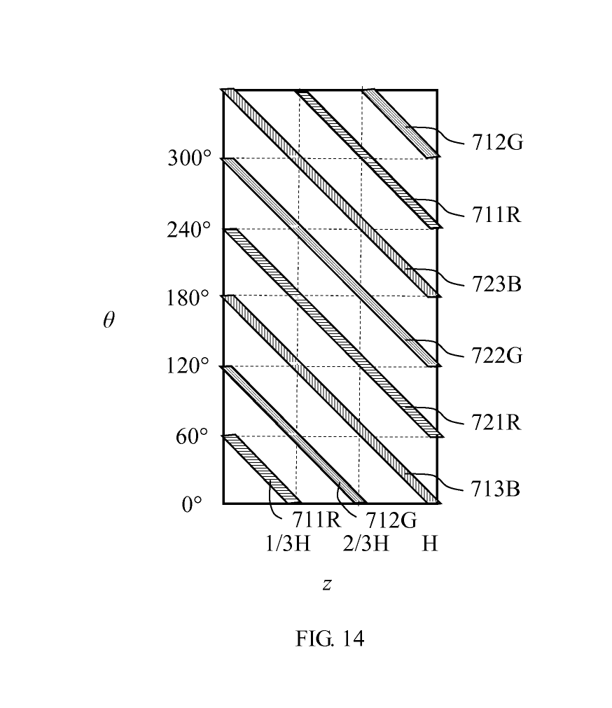

Please refer to FIG. 14 for a geometric arrangement schematic view of a dichroic mirror of a beam splitting apparatus in accordance with a third preferred embodiment of the present invention. As shown in the figure, H is the length alone the Z direction of the housing 701.

The red dichroic mirror 711R of the first dichroic mirror set 71 surrounds the shaft 703 spirally around half circle from θ=60° and the Z=0 position to θ=240° and the Z=H/2 position. The green dichroic mirror 712G surrounds the shaft 703 spirally around half circle from θ=120° and the Z=0 position to θ=300° and the Z=H/2 position. The blue dichroic mirror 713B surrounds the shaft 703 spirally around one circle from θ=180° and the Z=0 position to θ=0° and the Z=H/2 position.

The red dichroic mirror 721R of the first dichroic mirror set 72 surrounds the shaft 703 spirally around half circle from θ=240° and the Z=0 position to θ=60° and the Z=H/2 position. The green dichroic mirror 722G surrounds the shaft 703 spirally around half circle from θ=300° and the Z=0 position to θ=120° and the Z=H/2 position. The blue dichroic mirror 723B surrounds the shaft 703 spirally around one circle from θ=0° and the Z=0 position to θ=180° and the Z=H/2 position.

The dichroic mirror sets on the shaft are placed with a phase shift to each other such that the phase shift equals to the quotient of 360° dividing by the number of the dichroic mirror sets. There are two dichroic mirror sets in this embodiment, so the dichroic mirror sets are placed with 180° phase shift to each other. The number of turns of each dichroic mirror set encircling the shaft equals to the quotient of one dividing by the number of the dichroic mirror sets. There are two dichroic mirror sets in this embodiment, so the number of turns of each dichroic mirror set encircling the shaft is 0.5. The dichroic mirror sets are placed with a phase shift to each other such that the phase shift equals to the quotient of the phase shift of each dichroic mirror set dividing by the number of the dichroic mirrors on one dichroic or equals to the quotient of 360° dividing by the number of the dichroic mirrors. There are three dichroic mirrors (total 6) in each dichroic mirror sets (total 2) in this embodiment, and the phase shift of each dichroic mirror set is 180°, so the phase shift of each dichroic mirror is 60° (180°/3 or)360°/6=60°.

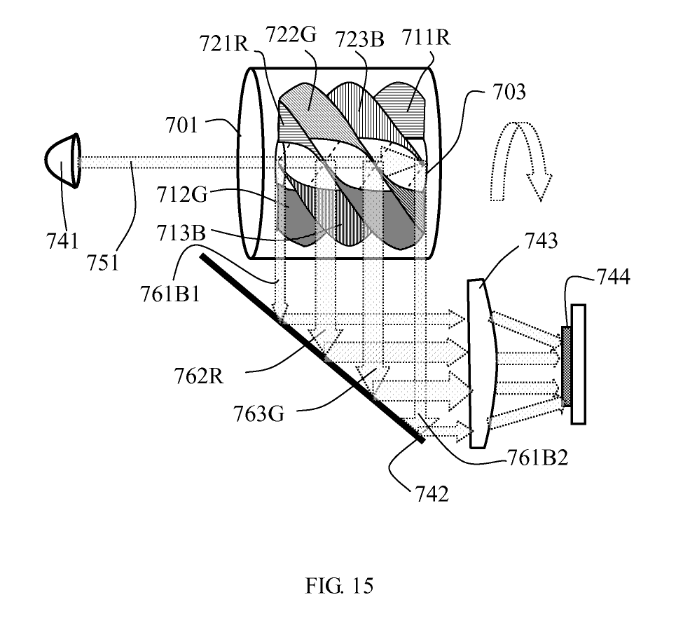

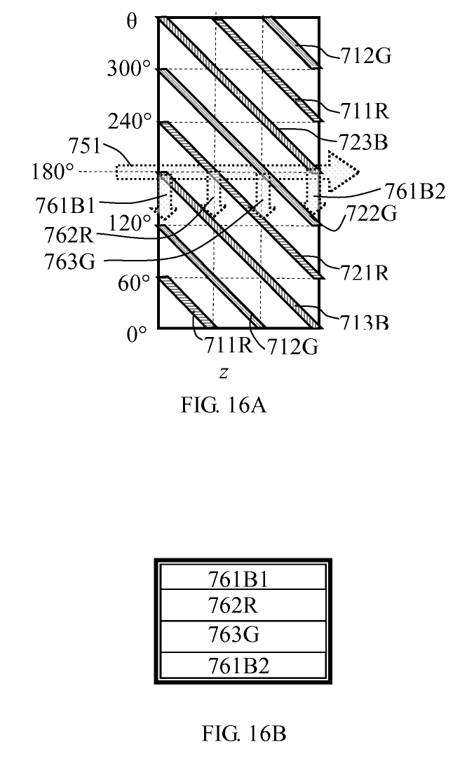

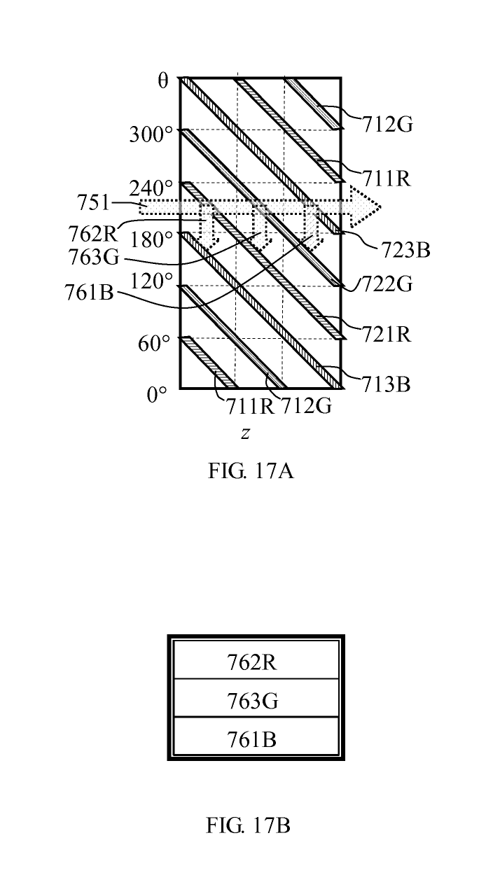

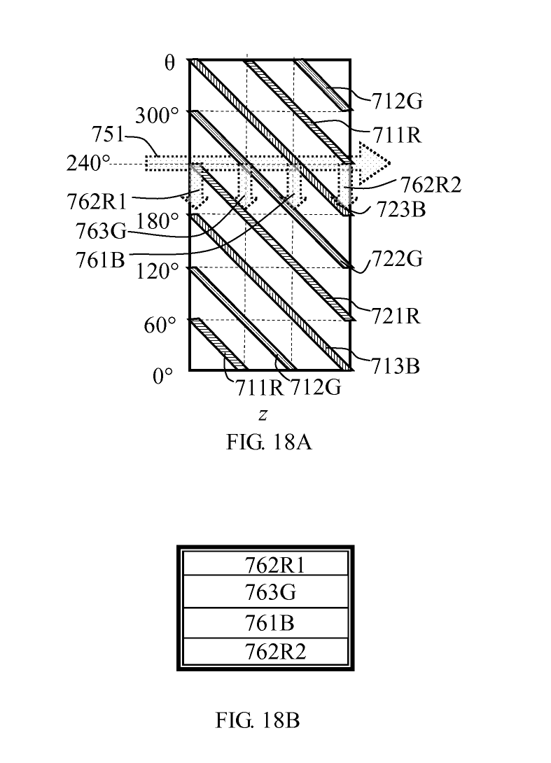

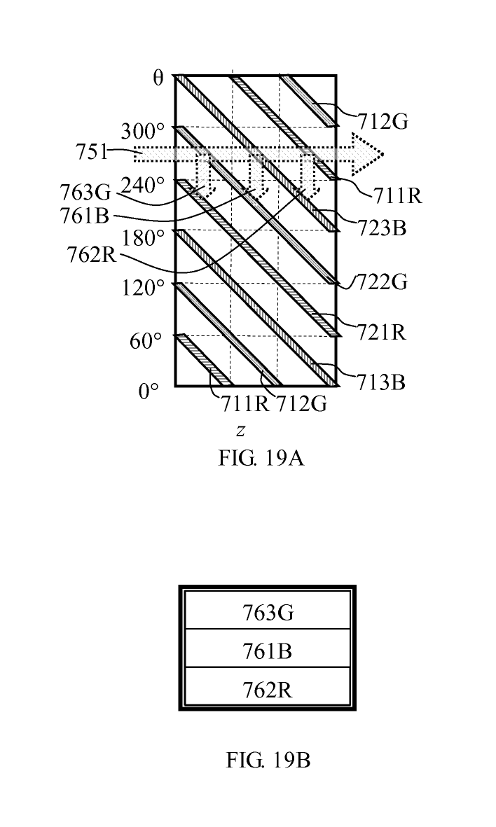

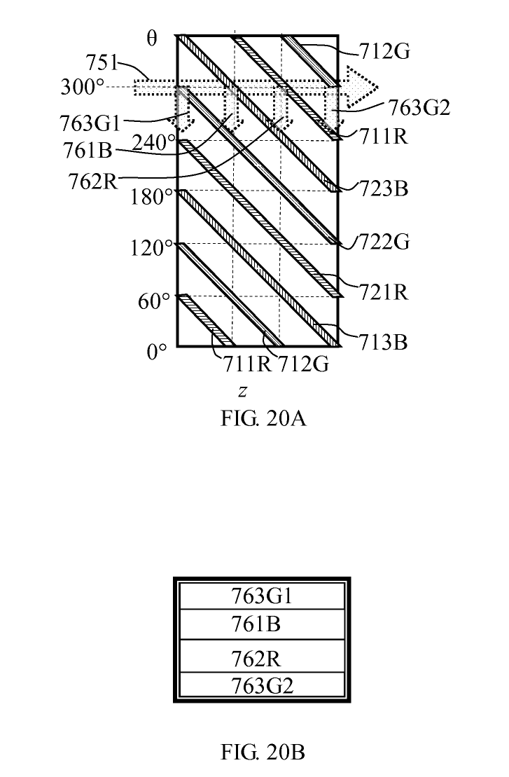

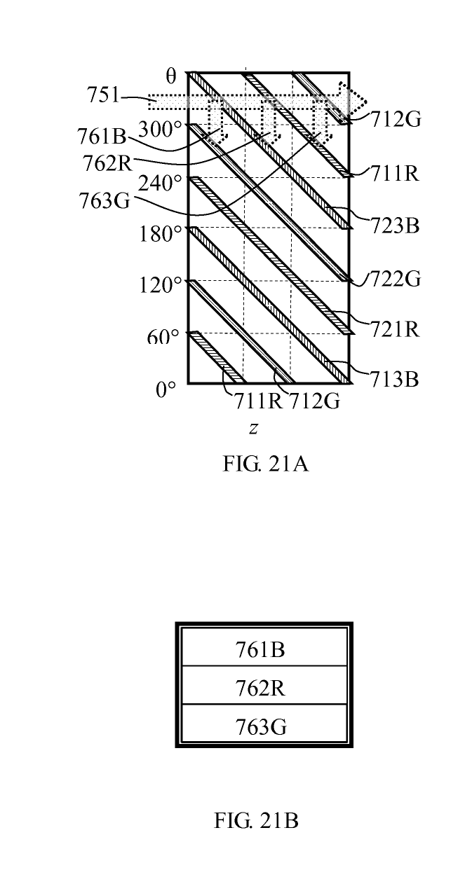

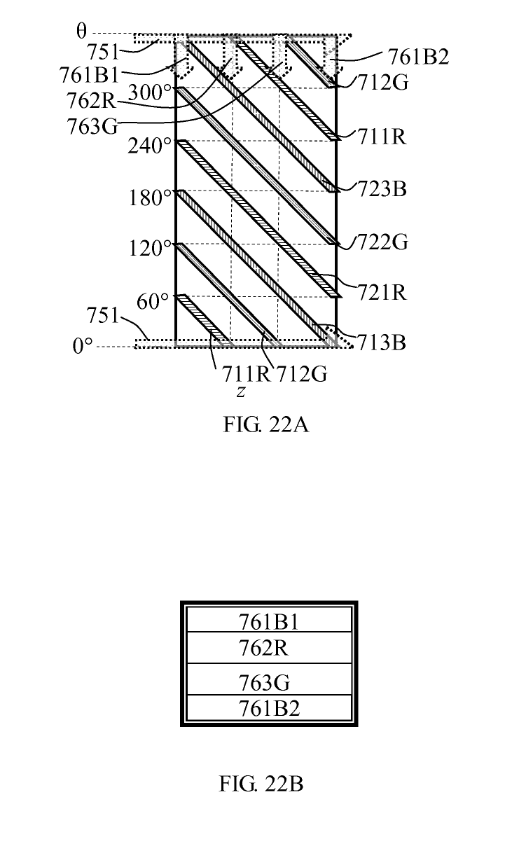

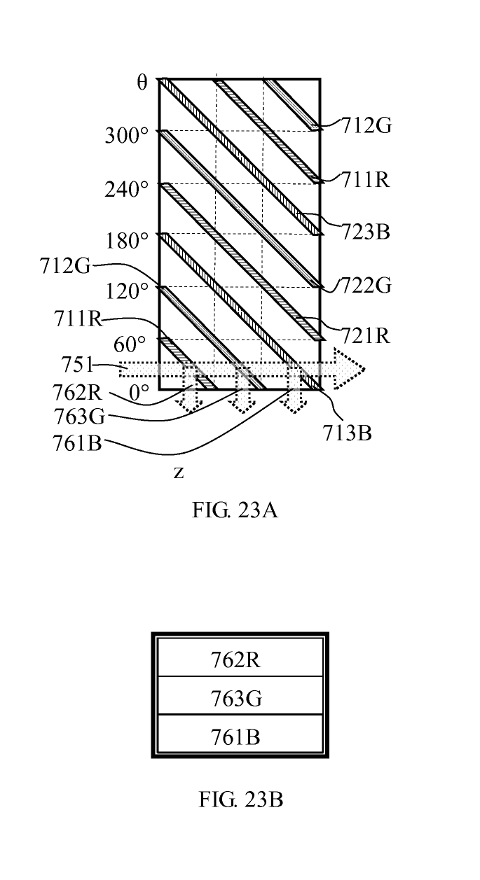

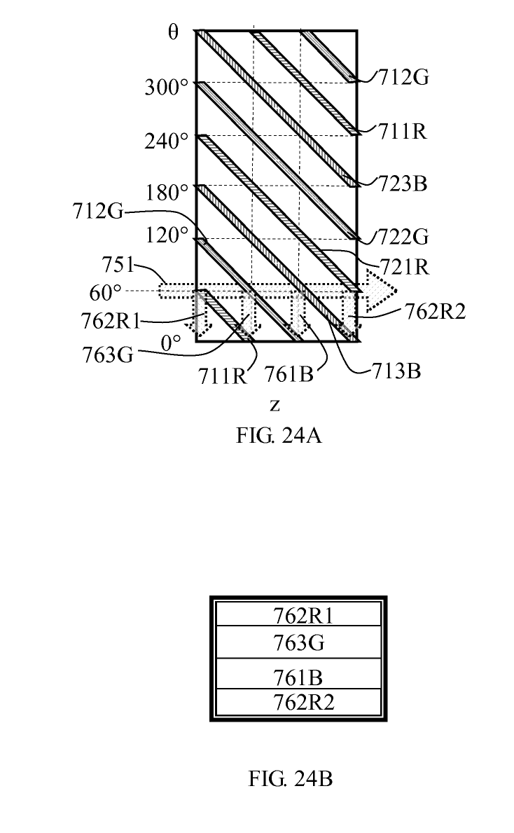

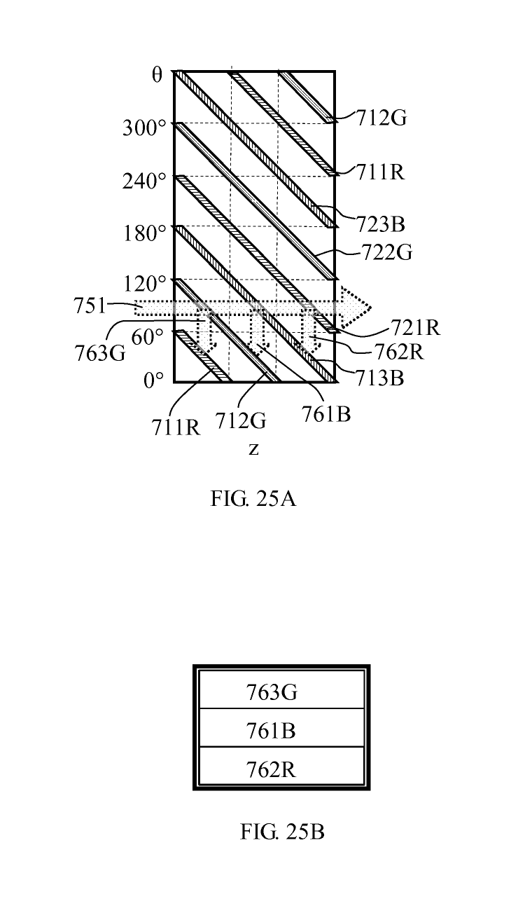

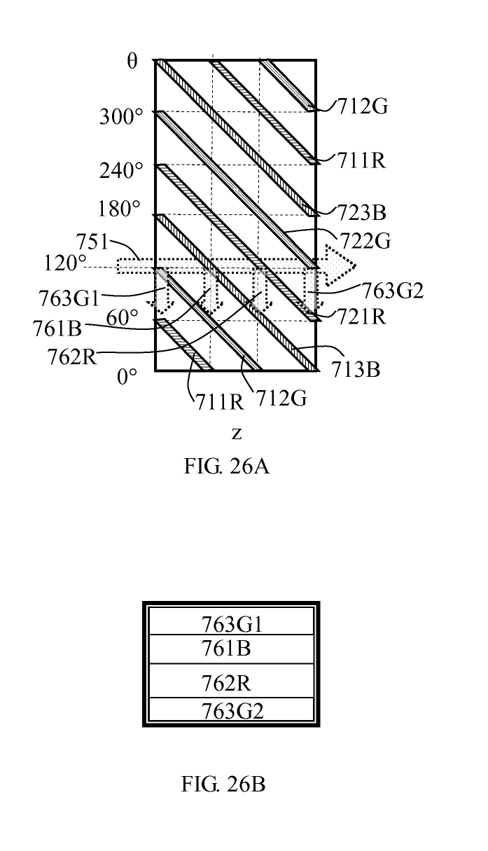

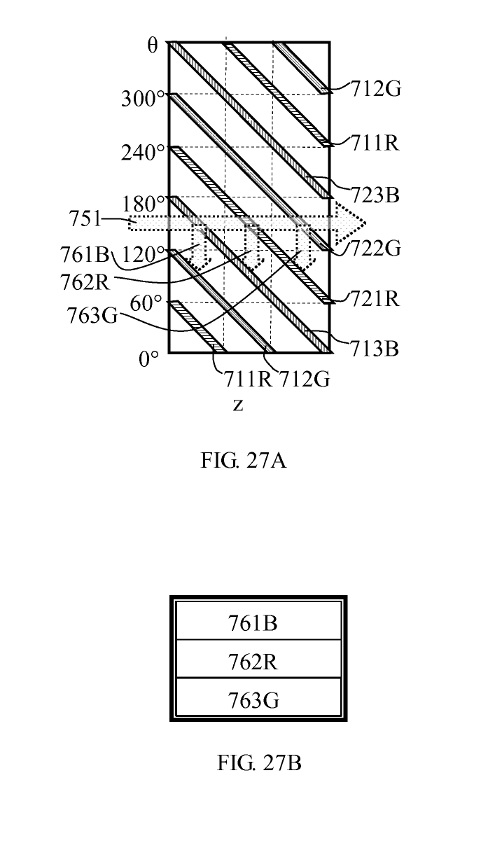

Please refer to FIG. 15 for a schematic view of a beam splitting apparatus in accordance with a second preferred embodiment of the present invention. The beam splitting apparatus of the present invention comprises a light source 741, a housing 701, a shaft 703, a first dichroic mirror set 71, a second dichroic mirror set 72, a reflective mirror 742, a relay lens set 743 and an display panel 744, wherein the first dichroic mirror set 71 comprises a red dichroic mirror 711R, a green dichroic mirror 712G and a blue dichroic mirror 713B, and the second dichroic mirror set 72 comprises a red dichroic mirror 721R, a green dichroic mirror 722G and a blue dichroic mirror 723B. Besides, the phase shift between the dichroic mirror sets on the shaft and the phase shift between the dichroic mirrors are the same as mentioned above, and the illustration will be omitted here.

The light source 741 is disposed in the front of the housing 701 and generates an incident light beam 751 to the beam splitting apparatus for splitting the incident light light beam 751.

In the present embodiment, the rotating angle of the housing 701 is 0°. For easily understanding the beam splitting sequence of the incident light beam 751, we just discuss the incident area 730 which is illuminated by part of the incident light beam 751 as shown in FIG. 13(B).

The incident light beam 751 is reflected by the blue dichroic mirror 713B to extract a blue light beam 761B1, and the other part of the incident light beam 751 passes through the blue dichroic mirror 713B to the red dichroic mirror 721R. Then the incident light beam 751 is reflected by the red dichroic mirror 721R to extract a red light beam 762R, and the other part of the incident light beam 751 passes through the red dichroic mirror 721R to the green dichroic mirror 722G. Then, the incident light beam 751 is reflected by the green dichroic mirror 722G to extract a green light beam 763G, and the other part of the incident light beam 751 passes through the green dichroic mirror 722G to the blue dichroic mirror 723B. The incident light beam 751 is reflected by the blue dichroic mirror 723B to extract a blue light beam 761B2, and the other part of the incident light beam 751 passes through the blue dichroic mirror 723B.

All reflected primary color beams (762R, 763G, 761B1 and 761B2) are reflected to the reflective mirror 742. The reflective mirror 742 is disposed on one side of the housing 701 in parallel to change the propagation directions of the primary color light beams (762R, 763G, 761B1 and 761B2), and reflects the primary color light beams (762R, 763G, 761B1 and 761B2) toward the relay lens set 743. The relay lens set 743 is disposed between the optical paths of the primary color light beams which have been reflected by the reflective mirror 742 in order to adjust the shape of the primary color light beams (762R, 763G, 761B1 and 761B2), integrate each primary color light beam and make the primary color light beams (762R, 763G, 761B1 and 761B2) toward the display panel 744. The display panel 744 is disposed between the optical paths of the primary color light beams which have transmitted through the relay lens 743 in order to modulate the integrated primary color light beams into an image of projection. With the rotation of the shaft 703, the appearing position of each primary color light beam in the display panel 744 periodically appears in the bottom of the display panel 744 and moves to the top of the display panel 744.

The difference between the beam splitting apparatuses of the first and second embodiments is that the appearing frequency of the primary color light beam of the present embodiment is twice to that of the first embodiment. The display frames per second are increased to enhance the image quality.

Please refer to FIGS. 16˜27 for an operation view of a beam splitting apparatus in accordance with a third preferred embodiment of the present invention. FIGS. 16˜27 show the relative incident position illuminated by the incident light beam 751 in the present beam splitting apparatus from the rotation 0° to the rotation 330° of the present beam splitting apparatus. FIGS. 16˜27 show the appearing position of a plurality of primary color beam (761B, 762R and 763G) appearing on the display panel 744. The beam splitting apparatus starts to rotate with the shaft from 0° to 360° circularly and smoothly. The appearing frequency of each primary color light beam (red, green and blue etc.) appearing on the display panel is twice to the rotating frequency of the shaft. Thus, the display frames per second are increased to enhance the image quality via doubling the numbers of dichroic mirrors.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A beam splitting apparatus, comprising:
a shaft rotating around an axis;
a plurality of dichroic mirrors spirally surrounding the shaft and disposed on the outer surface of the shaft, the dichroic mirrors rotating with the shaft to split an incident light beam into a plurality of primary color beams; and
a housing surrounding and sealing the shaft and the dichroic mirrors.

2. The beam splitting apparatus according to claim 1, wherein the shaft is a transparent hollow cylinder or a transparent solid cylinder.

3. The beam splitting apparatus according to claim 1, wherein the dichroic mirrors comprise a red dichroic mirror, a blue dichroic mirror and a green dichroic mirror, the dichroic mirrors disposed on the shaft are placed with 120° phase shift to each other, and the primary color beams comprise a red light beam, a blue light beam and a green light beam.

4. The beam splitting apparatus according to claim 1, wherein the dichroic mirrors comprise a red dichroic mirror, a blue dichroic mirror, a green dichroic mirror and a yellow dichroic mirror, the dichroic mirrors are placed with 90° phase shift to each other, and the primary color beams comprise a red light beam, a blue light beam, a green light beam and a yellow light beam.

5. The beam splitting apparatus according to claim 1, wherein the housing is formed in a transparent solid cylinder shape.

6. The beam splitting apparatus according to claim 1, wherein the housing is formed in a transparent hollow cylinder shape.

7. The beam splitting apparatus according to claim 6, wherein the inside of the housing is vacuum.

8. The beam splitting apparatus according to claim 1, wherein the housing rotates around the shaft.

9. The beam splitting apparatus according to claim 1, further comprising:
a light source disposed in the front of the housing and generating and projecting the incident light beam to the housing;
a reflective mirror disposed on one side of the housing in parallel to change the propagation directions of the primary color beams;
a relay lens set disposed between the optical paths of the primary color beams reflected by the reflective mirror in order to adjust the shapes of the primary color beams; and
an display panel disposed between the optical paths of the primary color beams transmitted through the relay lens in order to modulate and integrate the primary color beams into an image.

10. A beam splitting apparatus, comprising:
a shaft rotating around an axis; and
a plurality of dichroic mirror sets spirally surrounding the shaft and disposed on the outer surface of the shaft, the dichroic mirror sets rotating with the shaft to split an incident light beam into a plurality of primary color beams.

11. The beam splitting apparatus according to claim 10, further comprising a housing surrounding and sealing the shaft and the dichroic mirror sets.

12. The beam splitting apparatus according to claim 10, wherein the housing is formed in a transparent solid cylinder shape.

13. The beam splitting apparatus according to claim 10, wherein the housing is formed in a transparent hollow cylinder shape.

14. The beam splitting apparatus according to claim 13, wherein the inside of the housing is vacuum.

15. The beam splitting apparatus according to claim 11, wherein the housing rotates around the shaft.

16. The beam splitting apparatus according to claim 10, wherein the shaft is a transparent hollow cylinder or a transparent solid cylinder.

17. The beam splitting apparatus according to claim 10, wherein each dichroic mirror set comprises a plurality of dichroic mirrors, the dichroic mirrors comprise a red dichroic mirror, a blue dichroic mirror and a green dichroic mirror and the primary color beams comprise a red light beam, a blue light beam and a green light beam.

18. The beam splitting apparatus according to claim 17, wherein the dichroic mirror sets disposed on the shaft are placed with a first phase shift to each other such that the first phase shift equals to the quotient of 360° dividing by the number of the dichroic mirror sets, the number of turns of each dichroic mirror set encircling the shaft equals to the quotient of one dividing by the number of the dichroic mirror sets, and the dichroic mirrors of the dichroic mirrors sets disposed on the shaft are placed with a second phase shift to each other such that the second phase shift equals to the quotient of 360° dividing by the number of the dichroic mirrors.

19. The beam splitting apparatus according to claim 17, wherein the dichroic mirrors further comprise a yellow dichroic mirror, and the primary color beams further comprise a yellow light beam.

20. The beam splitting apparatus according to claim 11, further comprising:
a light source disposed in a distance from one end of the shaft and generating and projecting the incident light beam to the a plurality of dichroic mirror sets;
a reflective mirror disposed on one side of the housing in parallel to change the propagation directions of the primary color beams;
a relay lens set disposed between the optical paths of the primary color beams reflected by the reflective mirror in order to adjust the shape of the primary color beams; and
an display panel disposed between the optical paths of the primary color beams transmitted through the relay lens set in order to modulate the primary color beams into an image.
